(19) United States
(12) Patent Application Publication
(10) Pub. No.: US 2012/0154523 A1
(43) Pub. Date: Jun. 21, 2012

(54) Imaging System And Fisheye Lens System

(76) Inventors: Thomas Focke, Ahrbergen (DE); Reinhard Meschenmoser, Hannover (DE)

(21) Appl. No.: 13/323,974

(22) Filed: Dec. 13, 2011

(30) Foreign Application Priority Data
Dec. 21, 2010 (DE) 10 2010 063 618.5

(51) Int. Cl. H04N 5/225; G02B 13/06

(52) U.S. Cl. 348/36; 359/648; 348/E05.024

(57) ABSTRACT

A fisheye lens system for a driver assistance system in a motor vehicle has a field angle of at least approximately 180°, a lens of the lens system differing from a rotational body in that a usable image of the lens system is essentially rectangular.

### RELATED APPLICATION INFORMATION

The present application claims priority to and the benefit of German patent application no. 10 2010 063 618.5, which was filed in Germany on Dec. 21, 2010, the disclosure of which is incorporated herein by reference.

### FIELD OF THE INVENTION

The present invention relates to a fisheye lens system having the features described herein. Furthermore, the present invention relates to an imaging system having the features described herein.

### BACKGROUND INFORMATION

An on-board imaging system in a motor vehicle is used for optical scanning of the surroundings to provide data for a driver assistance system. The driver assistance system may be, for example, a lane assistant (lane departure warning, LDD) or a parking assistant. The imaging system usually has a lens system having a fisheye character to facilitate a simple and inexpensive design. The fisheye lens system usually has a field angle in the range of 180° and images the surroundings on an image sensor with some degree of distortion. Downstream from the image sensor, a processing device compensates for the distortion of the fisheye lens system, among other things.

German patent document DE 10 2005 043 412 A1 discusses a configuration of an optical system and an image sensor for an on-board recording device in a motor vehicle, in which optical axes of the optical system and of the image sensor are situated at an angle to one another.

Different distortions are possible with a fisheye lens system, depending on the curvature of a lens of the lens system. Some advantageous distortions are difficult to achieve optically, so they are implemented by post-processing or rectification of the recorded image.

A usable image created by a fisheye lens system is usually circular. If a rectangular image sensor having individual, regularly positioned image elements is used, such as that which is customary in digital cameras, then image elements outside of the circular usable image are superfluous. If the usable image is enlarged in comparison with the image sensor, for example, so that the diameter of the usable image corresponds to a diagonal of the image sensor, then all the image elements may be used for scanning the usable image, but a portion of the usable image is outside of the image sensor, so there is a loss of information.

### SUMMARY OF THE INVENTION

An object of the exemplary embodiments and/or exemplary methods of the present invention is therefore to provide a compact fisheye lens system of high quality as well as an imaging system equipped with same.

The exemplary embodiments and/or exemplary methods of the present invention achieves these object with the aid of a fisheye lens system having the features described herein and an imaging system having the features described herein. Also described are further specific embodiments.

A fisheye lens system according to the present invention for a driver assistance system in a motor vehicle has a field angle of at least approximately 180°, and a lens of a lens system differs from a rotational body in that a usable image of the lens system is essentially rectangular.

By using a lens having different degrees of curvature in different planes perpendicular to the optical axis, it is possible to design the usable image of the lens system to be rectangular instead of circular. This makes it possible, when the lens system has small dimensions, to minimize vignetting of the lens system, and an illumination of the usable image would be sufficiently uniform.

The lens may be shaped in such a way that an image of the lens system at least in an area close to the center of the usable image is essentially linearly divided. Furthermore, the lens may be shaped in such a way that the image of the lens system in the outer areas along one of the sides of the usable image is at least partially conformal.

The image is based on a property of the lens system such as an object, which is situated at a predetermined angle from the optical axis and is imaged at another predetermined distance from the optical axis in the usable image. Different imaging functions are differentiated here, a few being assigned the terms conformal, linearly divided, equal-area and orthographic. Mixed forms of these images are also possible, so that an at least partially conformal image is an image between a linear image and a conformal image.

In one specific embodiment, the lens has a first aspherical curvature at a midpoint section parallel to the first side of the usable image and has a second curvature differing from the first curvature at a midpoint section parallel to the second side of the usable image. The second curvature may be spherical or may also be aspherical. The fisheye effect may therefore assume different dimensions along the different directions of extent of the usable image. The distortion of the lens system may thus be adapted to an image requirement, for example, that of the driver assistance system.

Another lens may be provided between the lens and the image sensor for correction of an astigmatism caused by the lens. An astigmatism may be due to the different curvatures of the lens in different directions.

The lens may have an outline parallel to a plane of the usable image in the form of a rectangle or a figure whose outline is between the rectangle and a circle inscribed in the rectangle. Both the lens and the fisheye lens system may have a compact design due to the shape of the outline of the lens, which is approximated to that of a rectangle in this way.

The fisheye lens system may also include another lens, so that the lens which is closer to the plane of the usable image has an outline corresponding more to a rectangle, while the lens farther away from the plane of the usable image has an outline corresponding more to a circle. With different curvatures in different directions of the lens in particular, an imaging error in the form of an astigmatism may occur, but this is correctable by an additional lens in the beam path. The optical imaging may be optimized by the shaping of the outlines of the lenses as described here, while keeping the lens system compact at the same time.

An imaging system according to the present invention includes the fisheye lens system already described as well as an image sensor situated in the area of the usable image and a processing device for rectifying an image supplied by the image sensor as a function of the geometric image of the lens system. Through an appropriate choice of the image and the rectification, the rectified image may have a greater image quality than a comparable imaging system having rotationally symmetric lenses.

The exemplary embodiments and/or exemplary methods of the present invention will now be described in greater detail with reference to the accompanying figures.

### BRIEF DESCRIPTION OF THE DRAWINGS

FIG. 1 shows an imaging device.

FIG. 2 shows a lens of the imaging device of FIG. 1.

FIG. 3 shows a first section through the lens from FIG. 2.

FIG. 4 shows a second section through the lens from FIG. 2.

FIG. 5 shows a third section through the lens from FIG. 2.

FIG. 6 shows a top view of the lens from FIG. 2.

### DETAILED DESCRIPTION

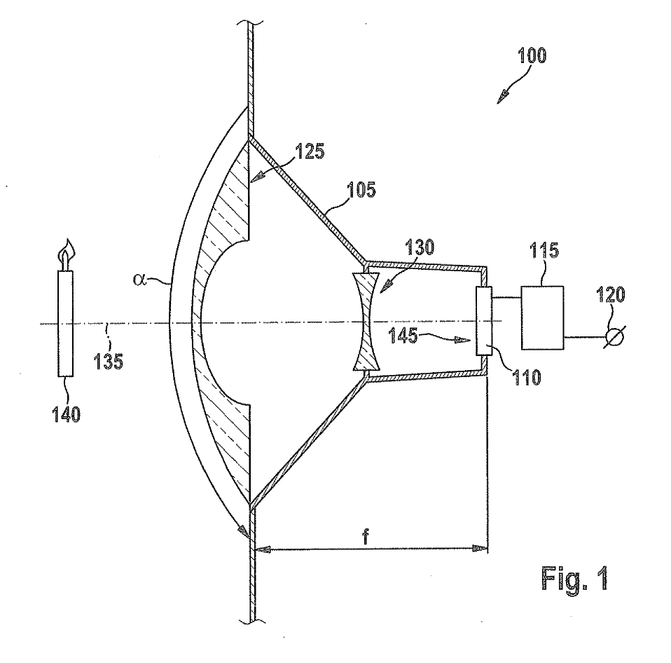

FIG. 1 shows an imaging device 100 of an on-board driver assistance system in a motor vehicle. Imaging device 100 includes a lens system 105, an image sensor 110 and a processing device 115. Image sensor 110 is usually a digital image sensor, for example, based on CCD. Image sensor 110 has a photosensitive surface, which is divided into individual pixels, the pixel density usually being the same along the sides of image sensor 110. Processing device 115 may be mounted on lens system 105 together with image sensor 110. In another specific embodiment, processing device 115 may also be situated at some distance from image sensor 110 and lens system 105 and may be connected to image sensor 110 by a cable, for example. Processing device 115 includes a programmable microcomputer, which is equipped to supply a processed image in digital form from the image data supplied by image sensor 110. Processing device 115 is connected to an interface 120 for this purpose.

In one specific embodiment, an evaluation of the driver assistance system may also be performed on processing device 115. The data supplied via interface 120 need not necessarily include processed image data but instead may represent primarily a processing result. Imaging device 100 may be a component of an on-board driver assistance system in a motor vehicle but may also be used in another area, for example, in panoramic photography.

Lens system 105 includes a first lens 125 and a second lens 130. In other specific embodiments, a greater or smaller number of lenses 125, 130 may also be included in lens system 105. Lenses 125, 130 may have concave or convex curvatures as needed and may also be cemented together, if necessary. Additional lenses 125, 130 may also be situated in lens system 105. Lenses 125, 130 of lens system 105 may be present individually or in groups. A conventional lens system 105 includes approximately twelve lenses in eight groups.

In the specific embodiment shown here, first lens 125 has an essentially round cross section and has a convex curvature toward the left and a concave curvature toward the right, a first curvature along the vertical and a second curvature perpendicular to the plane of the drawing being different from one another. Second lens 130 has a bilateral concave curvature, which may be different in the directions mentioned above. However, second lens 130 may also be rotationally symmetric and also spherical, if necessary. An outline of second lens 130 may be round or may approximate a rectangle more as an outline of first lens 125.

An optical axis 135 runs through the midpoints of lenses 125, 130 and through a midpoint on image sensor 110. An object 140 is represented on optical axis 135. After passing through first lens 125 and second lens 130, light emanating from object 140 strikes image sensor 110, where an image of object 140 is represented in a usable image 145 of lens system 105. An area in the plane of image sensor 110, in which an image of object 140 is represented but is extremely out of focus, distorted or underexposed, does not count as part of usable image 145. If all lenses 125, 130 of lens system 105 are rotationally symmetric, in particular with respect to optical axis 135, then usable image 145 is circular. Nonrotationally symmetric second lens 130 is shaped in such a way that usable image 145 of lens system 105 is rectangular. Image sensor 110 is positioned with respect to lens system 105 in such a way that margins of usable image 145 of lens system 105 correspond to margins of image sensor 110 in the most accurate manner possible.

In passing through lens system 105, the image of object 140 is distorted in the manner of a fisheye, so that objects are projected onto planar image sensor 110 in an extremely large field angle α of approximately 180°. The fisheye distortion within lens system 105 depends on the curvatures of the surfaces of lenses 125 and 130, among other things.

It is customary to use processing device 115 to simulate an image which is difficult or impossible to achieve by using the configuration and embodiment of lenses 125, 130. It is likewise possible to partially or completely compensate for an undesirable distortion of the image of lens system 105 with the aid of processing device 115. Both techniques may be used to influence the resolution of the finished image in pixels per unit of area at different locations in a targeted manner.

The image of lens system 105 in FIG. 1 is determined to a significant extent by the curvature of lens 130. This relates to both field angle α and an image of size and angular relationships of object 140 on image sensor 110. If object 140 is at a lateral angle w (field angle) to optical axis 135, then the image of lens system 105 results in an image position at a distance r from optical axis 135 on image sensor 110. If f is the focal distance of lens system 105, then the following terminology is used for special cases of the relationship between r and w:

conformal (stereographic): r=2f·tan(w/2);

linearly divided (equidistant): r=f·w;

equal-area (same space angle): r=2f·sin(w/2); and

orthographic: r=f·sin(w).

Outside of these special cases, mixed forms are also possible. Furthermore, it is possible to provide different images in different areas of image sensor 110. An image in the horizontal direction in particular may be different from an image in the vertical direction. In the vertical direction, second lens 130 may be uniformly divided linearly, and in the horizontal direction, it is linearly divided in a central part but is at least partially conformal in the outer parts.

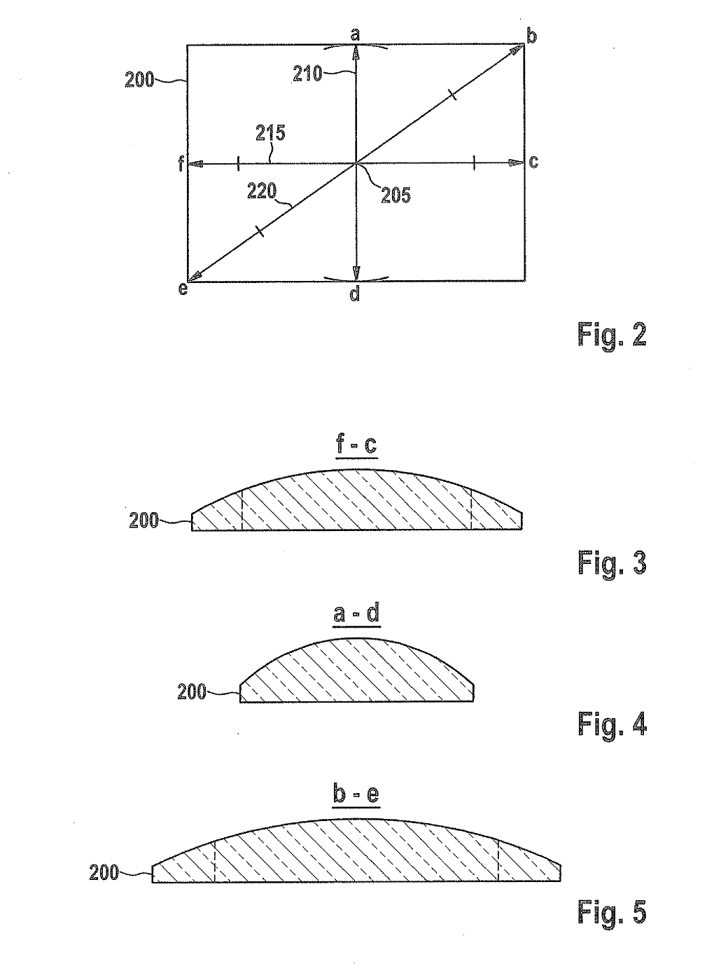

FIG. 2 shows a top view of a lens 200 for lens system 105 from FIG. 1. Lens 200 may correspond to second lens 130 in FIG. 1 in particular.

Lens 200 shown here has a rectangular outline. Three different intersecting lines 210, 215 and 220 run through a midpoint 205 of lens 200, i.e., through edge points a through e of lens 200. First intersecting line 210 connects edge points a and d, each of which cuts a horizontal side of lens 200 in half at the upper and lower edges of lens 200. Second intersecting line 215 connects points c and f, each of which cuts a vertical side of lens 200 in half on the right and left edges. Second intersecting line 220 connects lower left corner point e to upper right corner point b.

FIG. 3 shows a section through lens 200 along second intersecting line 215 (f-c), while FIG. 3 shows a section through lens 200 along first intersecting line 210 (a-d), and FIG. 4 shows a section through lens 200 along third intersecting line 220 (b-e). For the sake of simplicity, the case considered here is one in which the bottom side of lens 200 is planar and the top side has a convex curvature, but any other curvatures are also possible.

The curvatures along the different sections of FIGS. 3 through 5 are different. The curvature shown in FIG. 3 and/or the curvature shown in FIG. 4 is/are aspherical, i.e., the curved top sides of the corresponding cross sections do not constitute sections of a circular line. The curvatures may instead follow sections of parabolas or they may include several sections of different circular arcs.

A transition between the sections of FIGS. 3 and 4 takes place continuously; in other words, the surface of lens 200 has a curvature continuous in any direction which does not contain any break or jump. One example for another section through the lens 200 is shown in the diagonal section through lens 200 in FIG. 5.

Regardless of the shape of the outline of lens 200, curvatures of lens 200 are selected in such a way that a usable image of lens 200 corresponding to usable image 145 of lens system 105 from FIG. 1 has an essentially rectangular shape.

In another specific embodiment, the outline of lens 200 may also have a shape other than a rectangular shape. For example, a lens having a round outline may be cut out of rectangular lens 200 by cutting along a circular line around midpoint 205 with the diameter of intersecting line 210. Dividing lines in such an operation are shown as vertical dashed lines in the sectional views in FIGS. 2 and 5.

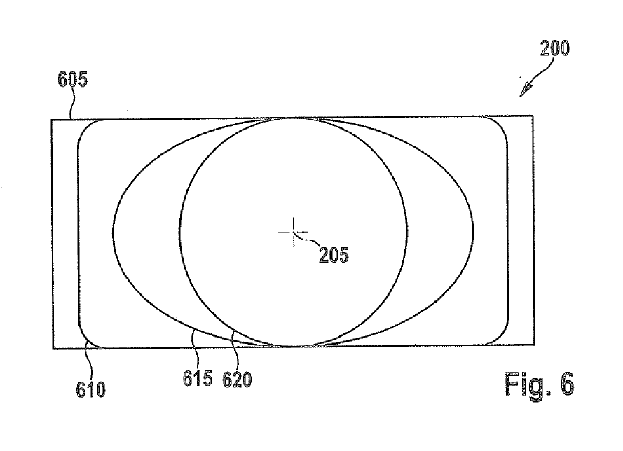

FIG. 6 shows different specific embodiments of lens 200 in a top view. All the outlines shown in FIG. 6 are symmetrical to midpoint 205 of lens 200, which may coincide with optical axis 135 of recording device 100 in FIG. 1.

A first outline 605 is rectangular in accordance with lens 200 in FIG. 2. A second outline 610 of lens 200 is essentially a rectangle having rounded corners, where the degree of rounding or the radius of the rounding may vary.

A third outline 615 is elliptical. The main axis of the ellipsis of third outline 615 extends horizontally in the specific embodiment shown in FIG. 6. A fourth outline 620 is circular. This specific embodiment corresponds to the circular specific embodiment mentioned with respect to FIGS. 2 through 5.

What is claimed is:

1. A fisheye lens system for a driver assistance system in a motor vehicle, comprising:
a lens arrangement having a field angle that is at least approximately 180°, wherein a lens of the lens arrangement differs from a rotational body so that a usable image of the lens arrangement is essentially rectangular.

2. The fisheye lens system of claim 1, wherein the lens is shaped so that an image of the lens arrangement is essentially linearly divided in at least an area of the usable image close to the center.

3. The fisheye lens system of claim 1, wherein the lens is shaped so that the image of the lens arrangement is at least partially conformal in the outer parts along one of the sides of the usable image.

4. The fisheye lens system of claim 1, wherein the lens has a first aspherical curvature in a midpoint section parallel to the first side of the usable image and has a second curvature which differs from the first curvature in a midpoint section parallel to the second side of the usable image.

5. The fisheye lens system of claim 4, wherein the curvatures of additional midpoint sections lie continuously between the two curvatures.

6. The fisheye lens system of claim 4, further comprising:
an additional lens for correcting an astigmatism caused by the lens, the additional lens being between the lens and the image sensor.

7. The fisheye lens system of claim 1, wherein the lens has an outline parallel to a plane of the usable image, this outline being in the form of a rectangle or a figure whose outline is between the rectangle and a circle inscribed in the rectangle.

8. The fisheye lens of claim 1, further comprising:
an additional lens situated closer to the plane of the usable image having an outline which corresponds more to a rectangle, while the lens situated farther away from the plane of the usable image has an outline corresponding more to a circle.

9. An imaging system, comprising:
a fisheye lens system for a driver assistance system in a motor vehicle, including a lens arrangement having a field angle that is at least approximately 180°, wherein a lens of the lens arrangement differs from a rotational body so that a usable image of the lens arrangement is essentially rectangular;
an image sensor situated in an area of the usable image; and
a processing device for rectifying an image supplied by the image sensor as a function of the geometric image of the lens system.
